(19) United States
(12) Patent Application Publication
(10) Pub. No.: US 2012/0239262 A1
(43) Pub. Date: Sep. 20, 2012

(54) Load-Carrying Vehicle Having a Vertically Adjustable Lifting Device

(76) Inventors: Ulrich Reinert, Sarstedt (DE); Peter Schubert, Leingarten (DE)

(21) Appl. No.: 13/496,076

(22) PCT Filed: Jul. 15, 2010
(86) PCT No.: PCT/EP2010/060197

§ 371 Date: May 25, 2012

(30) Foreign Application Priority Data
Sep. 15, 2009 (DE) 10 2009 029 467.8

(51) Int. Cl. B66F 9/075

(52) U.S. Cl. 701/50

(57) ABSTRACT

A load-carrying vehicle having a vertically adjustable lifting device for picking up a load, and an acceleration sensor system for measuring the acceleration in at least one direction of movement and having a sensor for ascertaining the picked-up load and having a sensor for ascertaining the lift height of the lifting device are described. Control signals for adjusting at least one power unit in the vehicle which influence the driving condition are generated in a regulating and control unit. The acceleration sensor system is situated on the lifting device.

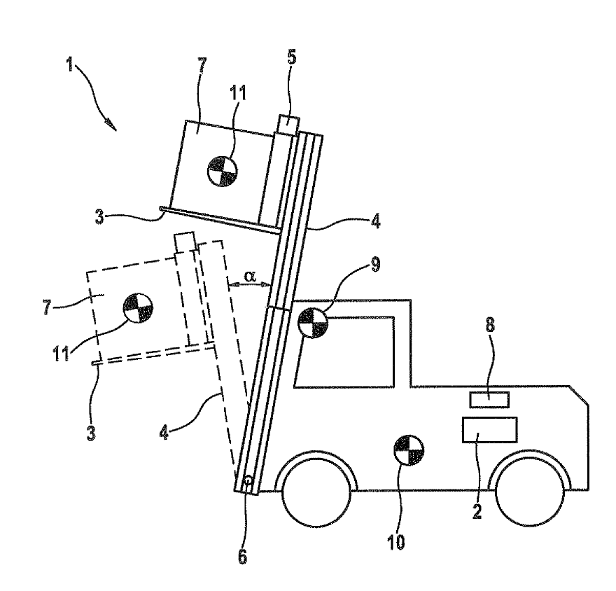

### FIELD OF THE INVENTION

The present invention relates to a load-carrying vehicle having a vertically adjustable lifting device, in particular an industrial vehicle such as a forklift truck.

### BACKGROUND INFORMATION

Patent document DE 103 04 658 A1 discusses an industrial vehicle, which is designed as a forklift truck and is equipped with a device for controlling driving stability in order to reduce the risk of tipping. There is the problem with forklift trucks in general that due to the short wheelbase, the small track width and the comparatively high center of gravity when the load is raised, there is an increased risk of tilting forward when braking and toward the side at high curve speeds. The device in DE 103 04 658 A1 for controlling driving stability includes a sensor system for ascertaining vehicle state variables and characteristics such as accelerations, picked-up load and lift height and a control device in which limiting values for admissible accelerations are ascertained on the basis of the measured variables, and measures are taken for maintaining the limiting values. Depending on the driving situation, the measures for increasing stability include a braking or acceleration operation, changing the lift height, intervening in the steering or intervening in the angular position of the mast carrying the lifting device.

With the aid of this device, the tipping risk may be significantly reduced, but the tilting risk is also influenced by dynamic factors, for example, vibration of the lifting fork, which is detected only inadequately via the control and regulation in the vehicle.

### SUMMARY OF THE INVENTION

The exemplary embodiments and/or exemplary methods of the present invention are based on the object of further reducing the tilting risk in a load-carrying vehicle having a vertically adjustable lifting device.

This object may be achieved according to the exemplary embodiments and/or exemplary methods of the present invention by the features described herein. The further descriptions herein define advantageous refinements.

The exemplary embodiments and/or exemplary methods of the present invention relate to load-carrying vehicles having a vertically adjustable lifting device, including in particular trackless industrial vehicles such as forklift trucks or reach stackers, but also tractors having front loaders, wheel loaders or the like. The exemplary embodiments and/or exemplary methods of the present invention are fundamentally also applicable to industrial vehicles running on tracks inasmuch as they are equipped with a vertically adjustable lifting device.

The load-carrying vehicle is equipped with an acceleration sensor system, which permits measurement of the acceleration in at least one direction of movement in addition to being equipped with the vertically adjustable lifting device to pick up a load to be transported. In addition, sensors for ascertaining the picked-up load and for ascertaining the lift height of the lifting device are provided. Control signals may be generated via a regulating and control unit in the load-carrying vehicle, which may be sent to at least one vehicle power unit for adjustment, upon its operation the driving state of the load-carrying vehicle being influenced. This power unit may be in particular a drive motor for driving the load-carrying vehicle and/or the brake unit, if necessary, also taking into account the influence on the steering mechanism in the vehicle as well as the lift height of the lifting device and, if necessary, the pivot angle of an adjustable mast for accommodating the lifting device.

The control signals are generated in particular at least as a function of the measured acceleration. The control signals may additionally also be a function of the ascertained picked-up load and the ascertained lift height.

It is provided according to the exemplary embodiments and/or exemplary methods of the present invention that the acceleration sensor system is situated on the lifting device and is vertically adjustable jointly with the lifting device. This design has the advantage that accelerations directly adjacent to the lifted load are ascertainable, so that dynamic changes in state such as vibrations, for example, to which the lifted load is exposed and which result in substantial forces acting on the vehicle, may be ascertained. Such dynamic processes are detected directly at the site of occurrence without any time lag, without any phase shift and without amplitude damping and may be processed in the regulating and control unit.

In contrast with designs from the related art, in which the acceleration sensor system is situated in a fixed chassis mount in the vehicle, a more sensitive instrument is available for recording accelerations to which the load is exposed. In the related art, however, such vibrations in the lifting device cannot be ascertained or may be ascertained only in a greatly attenuated and phase-shifted form. It is possible in this way to respond sooner to an imminent risk situation with the device according to the present invention than in the related art, so the tilting risk is further reduced. Additional risk situations may be detected in particular when driving over obstacles, and suitable measures may be taken to prevent or reduce the tilting risk.

The acceleration sensor system in or on the lifting device may be situated in such a way that with the loads usually to be picked up, the position of the acceleration sensor system is near the center of gravity of the load. However, an arrangement next to the highest point of the lifting device, which is subject to the greatest deflections based on the road surface, is also possible. However, an arrangement of the acceleration sensor system in the area of the forks on which the load to be lifted is to be placed is fundamentally also possible.

The acceleration sensor system includes an acceleration sensor, via which at least one acceleration in one direction of the vehicle, in particular the longitudinal acceleration, is measurable. However, the acceleration sensor system may be designed at least as a 2D acceleration sensor system, which includes sensors for measuring the longitudinal acceleration and the transverse acceleration. According to an advantageous embodiment, a 3D sensor system is provided, also including a sensor for measuring the vertical acceleration in addition to the sensors for measuring the longitudinal and transverse acceleration. The 3D acceleration sensor system has the advantage that tipping of the vehicle forward or to the rear is detectable with a higher precision via the vertical acceleration sensor together with the longitudinal acceleration sensor. The transverse acceleration may be used to influence cornering.

In addition to the acceleration sensor system, the load-carrying vehicle is equipped with a sensor for ascertaining the picked-up load, designed as a pressure sensor in a lift cylinder, which adjusts the lifting device, for example. Alternatively, with the aid of piezoelectric elements, the load situated between the lifting cylinder and the lifting device, for example, may be ascertained. The weight of the load is important information because the tilting risk is influenced by the weight of the load to a significant extent.

The load-carrying vehicle is additionally equipped with a sensor for ascertaining the instantaneous lift height of the lifting device because the lift height is also a definitive influencing factor on the tilting risk. The lift height is ascertained, for example, with the aid of a barometric sensor which is situated on the lifting device and is in particular a part of the sensor system on the lifting device, which also includes the acceleration sensor system. However, the pressure sensor and the lifting cylinder via which the lifting device may be adjusted are advantageously situated at the base of the lifting device.

However, the lift height of the lifting device may also be ascertained via a sensor device if necessary, with which a measurement of the vertical distance of the lifting device is possible. In this case, an arrangement of the sensor on the vehicle body as well as on the lifting device may be considered.

The lifting device may be situated on a mast attached to the vehicle body and held pivotably with respect to the vehicle body, in particular pivotable about a transverse axis. The pivotability is an additional degree of freedom of the load-carrying vehicle, which influences driving stability and is advantageously ascertained via an additional sensor.

Depending on the design of the load-carrying vehicle, various types of drive motors may be considered. For example, it is possible to have a design as an internal combustion engine or as an electric motor, the electric drive being possible via one or multiple drive motors acting on the vehicle axles as well as via wheel hub motors. An adjustment of the drive torque as well as of a motor braking torque via the drive motors may be considered. Additionally or alternatively, however, braking torques may also be adjusted via the braking device of the load-carrying vehicle, in particular via the wheel brakes. Furthermore, regulation of the height of the lifting device as well as the pivot angle of the mast, which carries the lifting device, may be considered. Furthermore, as far as this is possible in the load-carrying vehicle, the steering device of the load-carrying vehicle may also be influenced. For example, in a design of the steering device as a hydrostatic steering, automatic intervention into the steering system may be considered, likewise with active steering systems which allow presetting of a superimposed steering angle. In passive steering systems in which a superimposed steering angle cannot be generated, intervention into the servo control device is possible.

Additional advantages and advantageous embodiments are to be found in the additional description herein, and the description of the figure and/or the drawing, which shows a forklift truck with the load raised.

### BRIEF DESCRIPTION OF THE DRAWING

The Figure shows a forklift truck with the load raised.

### DETAILED DESCRIPTION

Forklift truck 1 shown in the figure has a drive motor 2 fixedly mounted on the body for driving one or both axles of the vehicle. A lifting device 3, which is designed as a lifting fork and is held in a vertically adjustable manner on a mast 4, is situated in the front area of forklift truck 1. Mast 4 may be pivoted by a pivot angle a between different positions in relation to the vehicle body, the pivot axis running in the transverse direction adjacent to the bottom of the vehicle. Lifting device 3 is held on mast 4 in a vertically adjustable manner via a suitable adjusting device, in particular via a hydraulically operable lifting cylinder, and may be adjusted between any positions, between the maximally lowered position and the maximally raised position on mast 4. Pivot angle a is adjusted independently of the vertical adjustment of lifting device 3.

Forklift truck 1 is equipped with a sensor system for detecting various state variables and characteristics of the vehicle. The sensor system includes a 3D acceleration sensor system 5, which is situated in the upper area of lifting device 3 and executes the same vertical control movement and the same pivoting movement about pivot angle α, in relation to the vehicle body, as lifting device 3. The longitudinal acceleration, the transverse acceleration and the vertical acceleration in lifting device 3 may be measured with the aid of acceleration sensor system 5.

In addition, the sensor system includes a pressure sensor 6, which is situated in the lifting cylinder, via which lifting device 3 is vertically adjustable on mast 4. The pressure sensor ascertains the pressure in the hydraulic medium, which adjusts the lifting cylinder. The weight of load 7, which is carried on lifting device 3, may be inferred from the measured pressure.

In addition, the sensor system includes a sensor for ascertaining the instantaneous lift height of the lifting device, for which purpose a design as a barometric sensor, which is situated on the lifting device, like acceleration sensor system 5, may be considered, for example. If necessary, the barometric sensor is situated in a shared housing with acceleration sensor system 5.

Essentially, however, alternative designs may be considered for the sensor for ascertaining the instantaneous lift height of lifting device 3, for example, distance sensors which are situated either at the base of mast 4 and ascertain the instantaneous lift height of lifting device 3, in relation to the base of the mast, or are fixedly connected to the lifting device and measure the distance of the lifting device from the base of the mast. In the latter case, the sensor for ascertaining the lift height is advantageously also situated in a shared housing together with acceleration sensor system 5.

In addition, a regulating and control unit 8 is provided in forklift truck 1, receives and analyzes the data ascertained by the sensor and, on the basis of these data, generates control signals via which the instantaneous driving state of the vehicle is influenceable. Drive motor 2, the braking device in the vehicle, the steering device, the lift height of lifting device 3 and pivot angle a of mast 4 in particular are set automatically via the control signals of regulating and control unit 8. Via the automatic adjustment of the actuators in the vehicle, influence is exerted on the driving stability in particular. Using the sensor system described here in the vehicle, the overall center of gravity 9 of the vehicle, which is composed of the center of gravity 10 of the vehicle and the center of gravity 11 of the load, may be determined, so that the instantaneous lift height and pivot angle a are to be taken into account in addition to the corresponding weight of load 7 for determining the overall center of gravity 9.

With the aid of 3D acceleration sensor system 5, which is fixedly connected to lifting device 3, accelerations and in particular also vibrations in lifting device 3 may be measured directly at the site of their formation, thus enabling a more rapid response by triggering the actuators in the vehicle, on the one hand, and, on the other hand, permitting a more precise adjustment in the limit ranges of stability. Both the longitudinal dynamics and the transverse dynamics of the vehicle may be taken into account, in particular the tilting risk about the transverse axis or the longitudinal axis of the vehicle.

1-13. (canceled)

14. A load-carrying vehicle, comprising:
a vertically adjustable lifting device for picking up a load; and
an acceleration sensor system for measuring the acceleration in at least one direction of movement, control signals for adjusting at least one power unit in the vehicle for influencing the driving state being generated in a regulating and control unit, wherein the acceleration sensor system is situated on the lifting device and is vertically adjustable together with the lifting device.

15. The load-carrying vehicle of claim 14, wherein the longitudinal acceleration is measurable via the acceleration sensor system situated on the lifting device.

16. The load-carrying vehicle of claim 14, wherein the transverse acceleration is measurable via the acceleration sensor system situated on the lifting device.

17. The load-carrying vehicle of claim 14, wherein the vertical acceleration is measurable in the acceleration sensor system situated on the lifting device.

18. The load-carrying vehicle of claim 14, wherein there is a sensor for ascertaining the picked-up load.

19. The load-carrying vehicle of claim 18, wherein the sensor for ascertaining the picked-up load includes a pressure sensor in a lifting cylinder which adjusts the lifting device.

20. The load-carrying vehicle of claim 14, wherein there is a sensor for ascertaining a lift height of the lifting device.

21. The load-carrying vehicle of claim 20, wherein the sensor for ascertaining the lift height of the lifting device includes a barometric sensor, which is situated on the lifting device.

22. The load-carrying vehicle of claim 14, wherein the lifting device is situated on a mast, which is pivotably mounted on the vehicle.

23. The load-carrying vehicle of claim 22, wherein there is a sensor for ascertaining the pivot angle of the mast.

24. The load-carrying vehicle of claim 14, wherein a drive motor of the load-carrying vehicle is adjustable by control signals of the regulating and control unit.

25. The load-carrying vehicle of claim 14, wherein a braking device of the load-carrying vehicle is adjustable by control signals of the regulating and control unit.

26. The load-carrying vehicle of claim 14, wherein the vehicle is an industrial vehicle.

27. The load-carrying vehicle of claim 14, wherein the vehicle is a forklift truck.

28. A regulating and control unit for generating control signals for influencing at least one power unit in a load-carrying vehicle, comprising:
a regulating and control arrangement for use with the load-carrying vehicle, the vehicle including a vertically adjustable lifting device for picking up a load, and an acceleration sensor system for measuring the acceleration in at least one direction of movement;
wherein the control signals for adjusting the at least one power unit in the vehicle for influencing the driving state are generated in the regulating and control arrangement, and
wherein the acceleration sensor system is situated on the lifting device and is vertically adjustable together with the lifting device.
